(19) United States
(12) Patent Application Publication
(10) Pub. No.: US 2026/0171896 A1
(43) Pub. Date: Jun. 18, 2026

(54) POWER CONVERTER

(71) Applicant: Renesas Design (UK) Limited, Bourne End (GB)

(72) Inventor: Der-Ju HUNG, New Taipei City (TW)

(73) Assignee: Renesas Design (UK) Limited, Bourne End (GB)

(21) Appl. No.: 18/985,965

(22) Filed: Dec. 18, 2024

(51) Int. Cl. H02M 1/088; H02M 1/00; H02M 3/158

(52) U.S. Cl. CPC H02M 1/088; H02M 1/0009; H02M 3/158

(57) ABSTRACT

A power converter includes a first converter stage receiving a first clock signal and a second converter stage receiving a second clock signal. The power converter is also provided with a clock circuit generating the first clock signal and configured to adjust a frequency of the first clock signal based on a load current.

### TECHNICAL FIELD

The present disclosure relates to a power converter, and in particular to a multi-stage power converter.

### BACKGROUND

Two-stage power converters can be used in a variety of applications for instance to lower an input voltage in two consecutive steps. Existing circuits are limited by a relatively poor efficiency, especially at light load.

It is an object of the disclosure to address one or more of the above mentioned limitations.

### SUMMARY

According to a first aspect of the disclosure, there is provided a power converter comprising a first converter stage adapted to receive a first clock signal; a second converter stage adapted to receive a second clock signal; and a clock circuit configured to generate the first clock signal and to adjust a frequency of the first clock signal based on a load current.

Optionally, the clock circuit is configured to increase the frequency of the first clock signal above a default frequency when the load current increases above a first threshold value and to lower the frequency of the first clock signal below the default frequency when the load current decreases below a second threshold value.

Optionally, the clock circuit is configured to estimate the load current based on a sense signal from the second converter stage.

Optionally, the sense signal comprises a voltage indicative of an inductor current of the second converter stage.

Optionally, the clock circuit comprises an operation frequency control loop coupled to an oscillator, the operation frequency control loop being configured to generate a control signal to adjust the frequency of the first clock signal generated by the oscillator.

Optionally, the clock circuit comprises a plurality of comparators, each comparator being configured to compare the sense signal from the second converter stage with a reference value associated with the comparator, and to provide a comparison signal.

Optionally, the operation frequency control loop is configured to estimate the load current using a look up table listing a plurality of load current values associated with corresponding sense signal values.

Optionally, the power converter comprises a clock generator configured to generate the second clock signal.

Optionally, wherein the first converter stage comprises one or more capacitive divider; and wherein the second converter stage comprises one or more buck converter.

Optionally, wherein the first converter stage comprises a plurality of capacitive dividers coupled in series, and wherein the clock circuit is configured to provide the first clock signal to at least one of the capacitive dividers.

Optionally, wherein the first converter stage comprises one or more charge pump; and wherein the second converter stage comprises one or more boost converter.

Optionally, wherein the second converter stage comprises a plurality of phases and wherein the power converter further comprises an integrator configured to sum sense signals from each phase.

According to a second aspect of the disclosure, there is provided a method of operating a power converter having a first converter stage and a second converter stage, the method comprising
generating a first clock signal for the first converter stage; and
adjusting a frequency of the first clock signal based on a load current.

Optionally, the first clock signal has a default frequency, the method further comprising
estimating the load current;
increasing the frequency of the first clock signal above the default frequency when the load current increases above a first threshold value; and
lowering the frequency of the first clock signal below the default frequency when the load current decreases below a second threshold value.

Optionally, the method comprises maintaining the first clock signal with the default frequency when the load current is between the first threshold value and the second threshold value.

### DESCRIPTION OF THE DRAWINGS

The disclosure is described in further detail below by way of example and with reference to the accompanying drawings, in which:

FIG. 1 is a diagram of a two-stage power converter according to the prior art;

FIG. 2 is a diagram of a modified version of the two-stage power converter of FIG. 1;

FIG. 3 is a flow chart of a method for operating a two-stage power converter according to the disclosure;

FIG. 4 is a diagram of a two-stage power converter according to the disclosure;

FIG. 5 is an example implementation of the power converter of FIG. 4;

FIG. 6A is an example implementation of a voltage clock control system;

FIG. 6B is a lookup table for use by the operation frequency control loop circuit;

FIG. 6C is an example implementation of an oscillator for use in the circuit of FIG. 6A;

FIG. 6D is a plot illustrating the operation of the oscillator of FIG. 6C;

FIG. 7 is a flow diagram illustrating the operation of the operation frequency control loop circuit of FIG. 6A;

FIG. 8A is a diagram of a multi-output power converter according to the disclosure;

FIG. 8B is a diagram of a multi-phase single-output power converter;

FIG. 9 is an example implementation of a voltage integrator for use in the circuit of FIGS. 8A and 8B;

FIG. 10A is a diagram of power converter with multiple capacitive dividers according to the disclosure;

FIG. 10B is a modified version of the power converter of FIG. 10A;

FIG. 11 is a diagram of an exemplary capacitive divider for use in the circuit of FIG. 5 or 8.

### DESCRIPTION

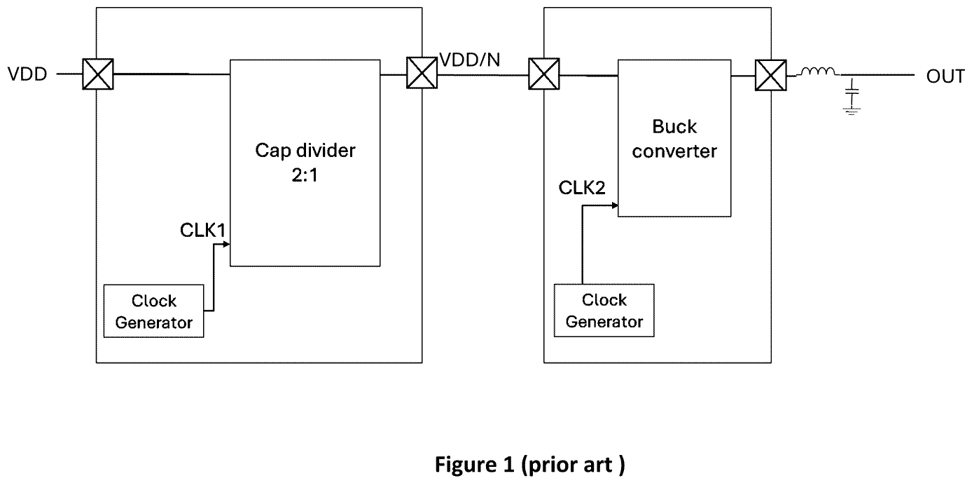

FIG. 1 is a diagram of a two-stage power converter according to the prior art. The first stage includes a capacitive divider to divide the rail voltage VDD by a predetermined ratio, and output VDD/N. For instance, the capacitive divider may be 2:1 to divide VDD by 2 or, or 3:1 to divide VDD by 3 etc.

The second stage includes a buck converter that receives the output of the first stage VDD/N and provides an output voltage Vout. The capacitive divider receives a first clock signal CLK1 from a first clock generator. Similarly, the buck converter receives a second clock signal CLK2 from a second clock generator. The clock signals CLK1 and CLK2 are both fixed.

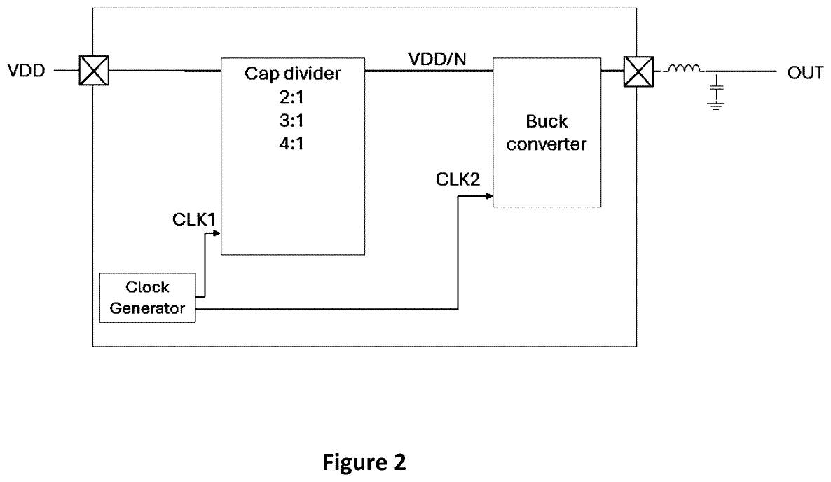

FIG. 2 is a diagram of a modified version of the two-stage power converter of FIG. 1. In this example a single clock generator is used to generate the fixed clock signals CLK1 and CLK2. In the circuits described in FIGS. 1 and 2 the capacitive divider has a high gate driving loss at light load, hence a reducing the efficiency of the system.

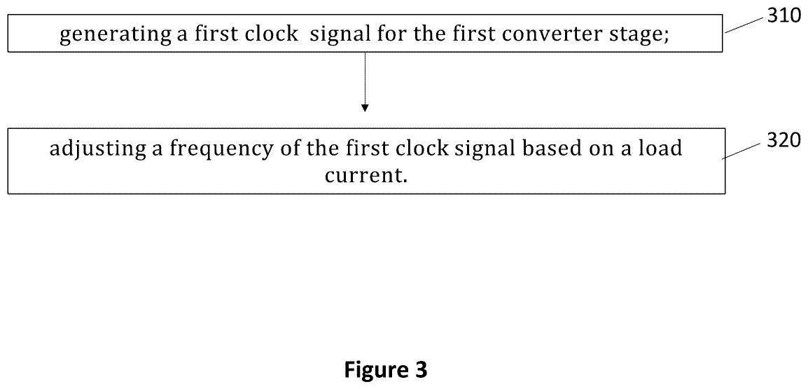

FIG. 3 is a flow chart of a method for operating a power converter having a first converter stage and a second converter stage according to the disclosure. At step 310 a first clock signal is generated for the first converter stage. At step 320 a frequency of the first clock signal is adjusted based on a load current.

For instance the load current may be estimated and compared with predetermined threshold values before adjusting the frequency of the first clock signal. Two load current threshold values may be used: a first threshold, also referred to as high threshold value, and a second threshold value also referred to as low threshold value.

In this example the frequency of the first clock signal is increased when the load current (or estimated value) increases above a first threshold value, and the frequency of the first clock signal is lowered when the load current (or estimated value) decreases below a second threshold value. Using this approach permits to improve efficiency at light current load. It also improves the driving capability at heavy load.

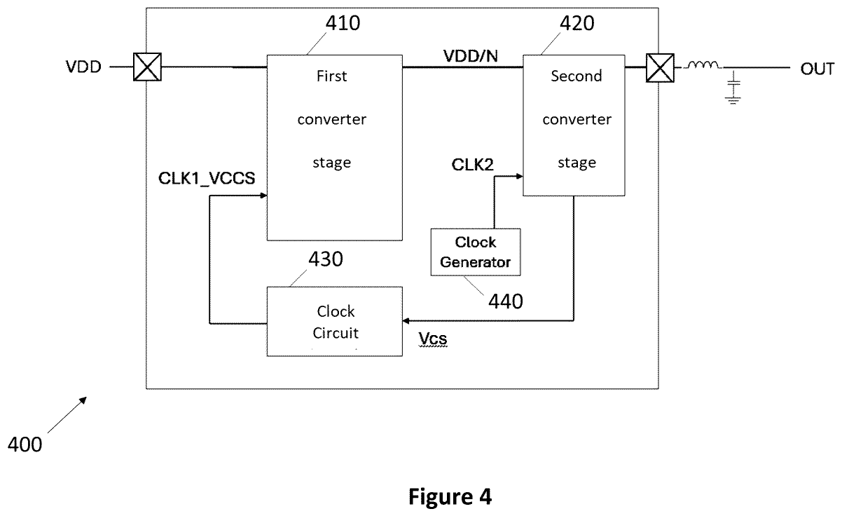

FIG. 4 is a diagram of a two-stage power converter according to the disclosure. The power converter 400 includes two converter stages 410, 420 and a clock circuit 430. The first converter stage 410 is adapted to receive a first clock signal. The second converter stage 420 is adapted to receive a second clock signal. The clock circuit 430 is configured to generate the first clock signal and to adjust a frequency of the first clock signal based on a load current. A clock generator 440 is provided to generate the second clock signal.

The power converter 400 may be implemented as a step down converter. In this case the first converter stage 410 would include one or more capacitive divider, and the second stage 420 one or more Buck converters.

The power converter 400 may also be implemented as a step up converter. In this case the first converter stage 410 would include one or more charge pumps, and the second stage 420 one or more Boost converters.

In operation the clock circuit 430 receives a sense signal such as a current sense voltage Vcs from the second converter stage 420, and provides a clock signal CLK1_VCCS to the first converter stage 410. The current sense voltage Vcs is indicative of the current IL passing through the inductor of the second converter stage 420.

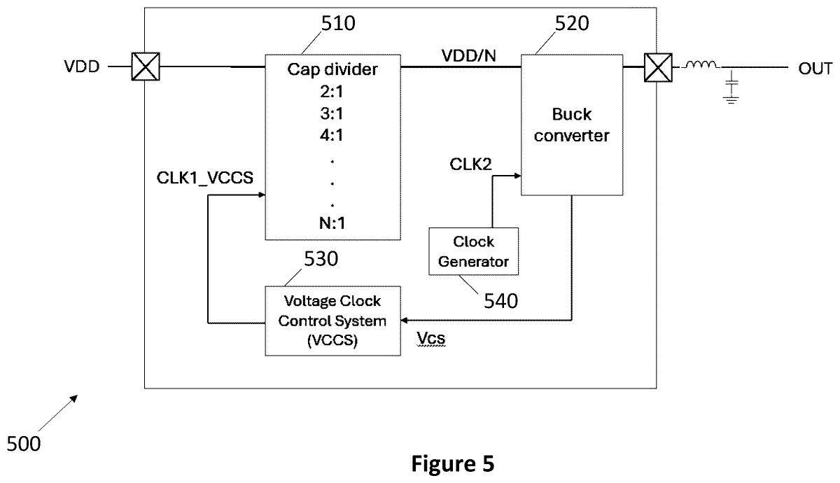

FIG. 5 is an example implementation of the power converter of FIG. 4. In this example the first converter stage 510 includes a capacitive divider, and the second converter stage 520 includes a Buck converter. The clock circuit 530 is implemented as a voltage clock control system (VCCS).

In operation the VCCS 530 receives the current sense voltage Vcs from the buck converter 520, and provides a clock signal CLK1_VCCS to the capacitive divider 510. The current sense voltage Vcs is indicative of the current IL passing through the inductor of the Buck converter. The voltage Vcs may be obtained in different ways. For instance Vcs may be related to the drain to source voltage Vds of the high side power switch or the low side power switch of the Buck converter.

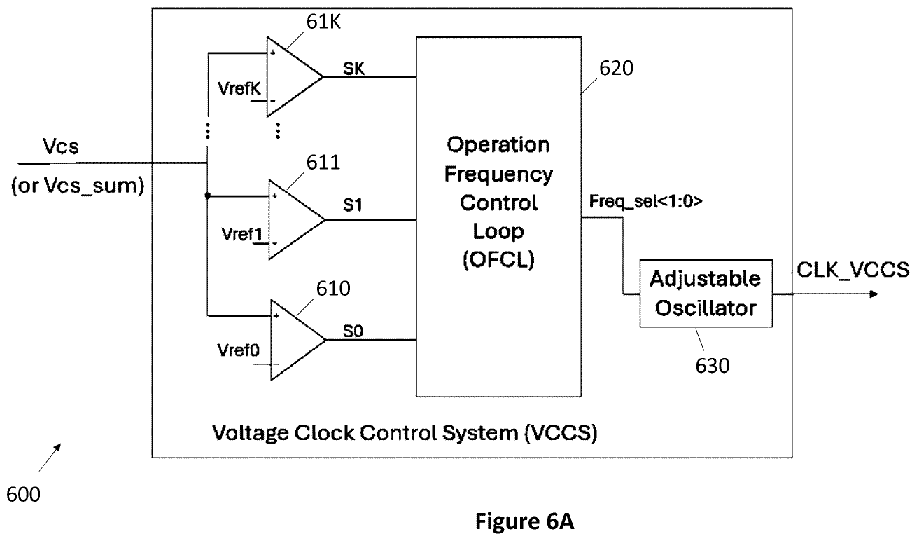

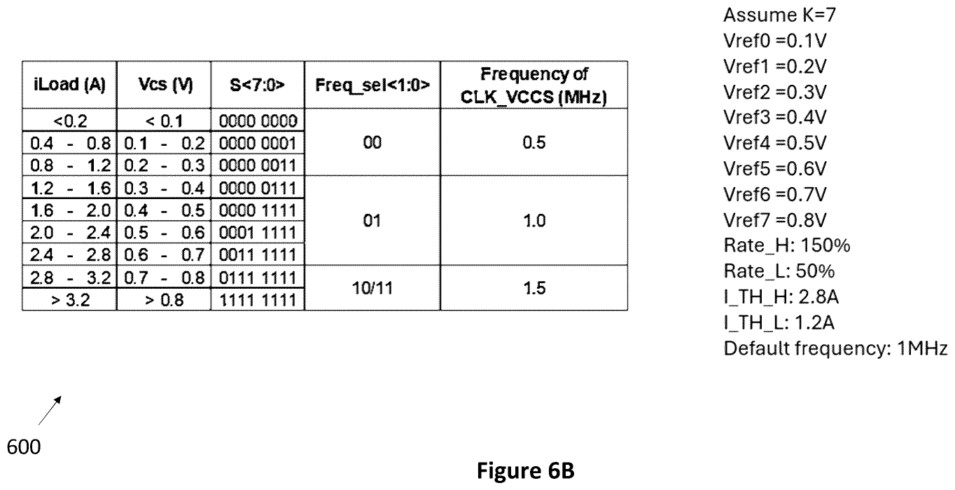

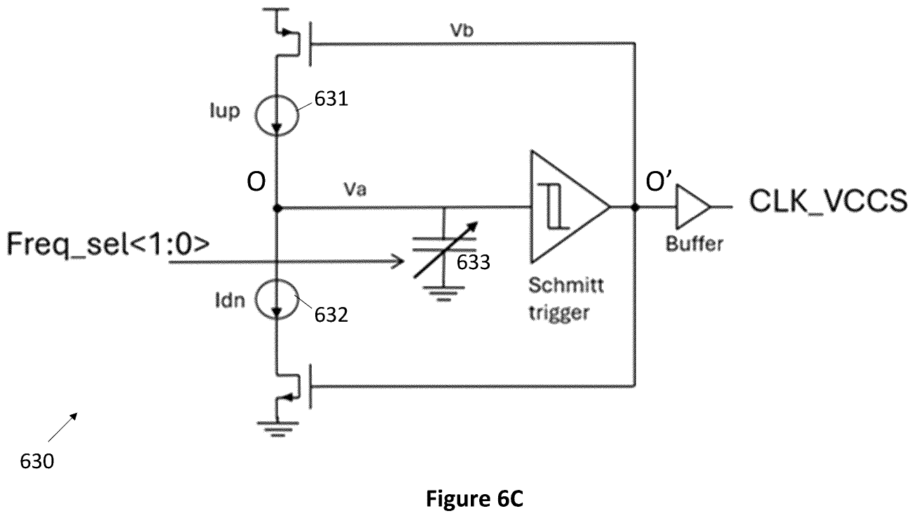

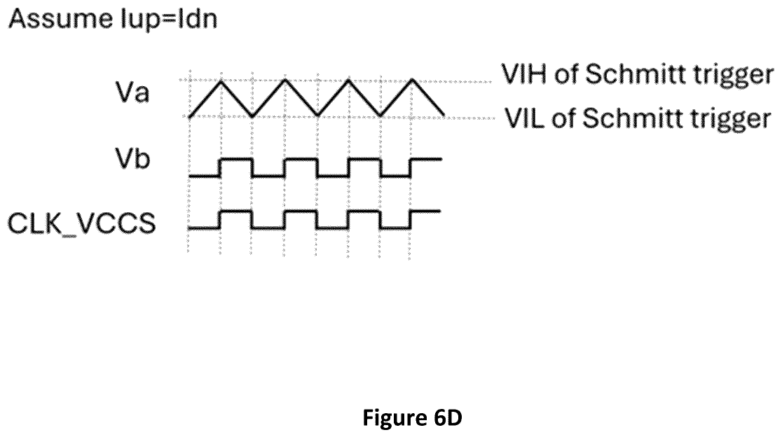

FIG. 6A is an example implementation of a voltage clock control system. The voltage clock control system 600 includes a plurality K of comparators 610-61K coupled to an operation frequency control loop (OFCL) 620. Each comparator has a first input, for instance a non-inverting input for receiving the voltage Vcs, and a second input, for instance an inverting input, for receiving a reference voltage Vrefi, in which Vrefi is a reference voltage specific to the comparator. The comparator 610 has a reference voltage Vref0, the comparator 611 has a reference voltage Vref1, and the comparator 61K has a reference voltage VrefK. The voltages Vref0, Vref1 . . . , VrefK may be chosen such that Vref0<Vref1<Vref2 . . . <VrefK. In a numerical example, K=7 and each reference voltage increases by an equal amount of 0.1V so that Vref0=0.1V, Vref1=0.2V and Vref7=0.8V.

The output of each comparator is a comparison signal indicative of the whether Vcs is lower of greater than Vref. If Vcs is less than Vref then the comparator outputs a comparison signal having a logic low (logic 0). If Vcs is greater than Vref then the comparator outputs a comparison signal having a logic high (logic 1).

The OFCL 620 receives the comparison signals S0, S1 . . . SK of each one of the comparators 610-61K and generates a control signal Freq_sel<1:0> to adjust the frequency of the clock signal generated by the oscillator 630. The OFCL 620 may be implemented as a digital circuit.

FIG. 6B shows an exemplary lookup table for use by the operation frequency control loop. For different Vcs voltage values, the lookup table provides a corresponding a load current value iLoad. The comparison signals S0, S1 . . . SK are used by the OFCL to identify Vcs, and the corresponding current load. Different ranges of iLoad correspond to different control signal values. The control signal Freq_sel<1:0> is then used to adjust the frequency of the first clock. In this example, Freq_sel<1:0>=01 maintains the frequency to 1 MHz. When Freq_sel<1:0>=00 the frequency decreases to 0.5 MHz, and when Freq_sel<1:0>=10/11 the frequency increases to 1.5 MHz.

FIG. 6C is an example implementation of an oscillator for use in the circuit of FIG. 6A. In this example the oscillator 630 includes two current sources 631, 632 coupled at node O and providing currents Iup and Idn respectively. A variable capacitor 633 has a first terminal coupled to node O and a second terminal coupled to ground. A Schmitt trigger has an input coupled to node O and an output coupled to a buffer at node O′. The output of the buffer provides the clock signal CLK1_VCCS. A first switch M1 connects the 631 to an input voltage and a second switch M2 connects 632 to ground. The gate of M1 is coupled to the gate of M2 and to the output of the Schmitt trigger at node O′.

FIG. 6D is a plot illustrating the operation of the oscillator of FIG. 6C, showing the voltage Va at node O, the voltage Vb at node O′ and the clock signal CLK1_VCCS. In operation, the control signal Freq_sel<1:0> is used to vary to vary the capacitance C of the variable capacitor 633, hence adjusting the frequency of the clock signal CLK1_VCCS.

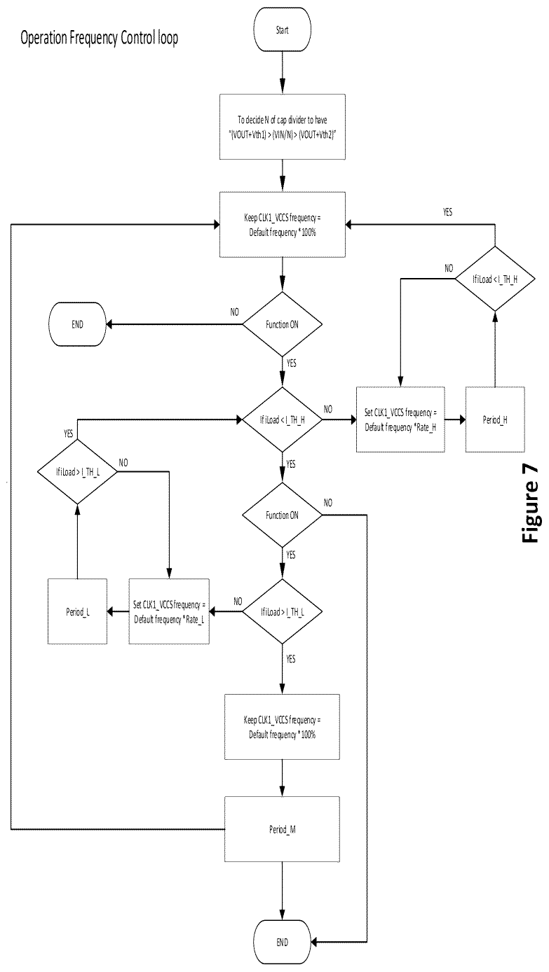

FIG. 7 is a flow diagram illustrating the operation of the operation frequency control loop circuit of FIG. 6A. Various parameters are defined as follows:
Vth1 is a first threshold voltage to setup the N number, that is the ratio N:1 of the capacitive divider. Vth2 is a second threshold voltage to setup N number. The default frequency is a predefined value, for instance 1 MHz.
The Period_H is the time period to keep the higher frequency equal to the default frequency*Rate_H.
The Period_L is the time period to keep the lower frequency equal to default frequency*Rate_L.
The Period_M is the time period to keep the default frequency equal to default frequency*100%.
The Rate_H is the rate to have higher frequency. The Rate_L is the rate to have lower frequency. The Rate may be expressed as a percentage of the default frequency, for instance more than 100% or less than 100%.

I_TH_H is the load current threshold to switch to higher cap divider operation frequency. I_TH_L is the load current threshold to switch to lower cap divider operation frequency.

Upon start, the OFCL select the ratio N:1 of the capacitive divider based on the threshold voltages Vth1 and Vth2, such that

$$( VOUT + Vth 1 ) > ( V IN / N ) > ( VOUT + Vth 2 ) .$$

The clock signal CLK1_VCCS is then set to the default frequency. The function to adjust the clock frequency may be activated ON/OFF depending on the efficiency of the power converter. At relatively low efficiency, the function is turned ON. Then the frequency of the clock signal is adjusted based on the two current threshold I_TH_H and I_TH_L.

When ILoad is between I_TH_H and I_TH_L the frequency of the clock signal is maintained at the default frequency.

When ILoad is greater than I_TH_H the frequency of the clock signal is increased. The capacitive divider switching frequency becomes higher to provide sufficient driving capability.

When ILoad is lower than I_TH_L the frequency of the clock signal is decreased. As a result the capacitive divider switching frequency becomes lower, hence reducing gate driving loss.

In an exemplary numerical example, the above parameters may be set with the following values:
Vth1: 1V, Vth2: 0.3V
Default frequency: 1 MHz
Period_H: 1 ms, Period_L: 1 ms, Period_M: 1 ms
Rate_H: 150%, Rate_L: 50%
I_TH_H: 2.8 A, I_TH_L: 1.2 A

The flow diagram of FIG. 7 is provided for the case of a power converter implemented for step down conversion. For a power converter implemented for step up conversion, the flow diagram would remain the same apart from the first step (after start). In this scenario upon start, the OFCL would select the factor N of the charge pump based on the threshold voltages Vth1 and Vth2, such that (VOUT+Vth1)>(VIN*N)>(VOUT+Vth2).

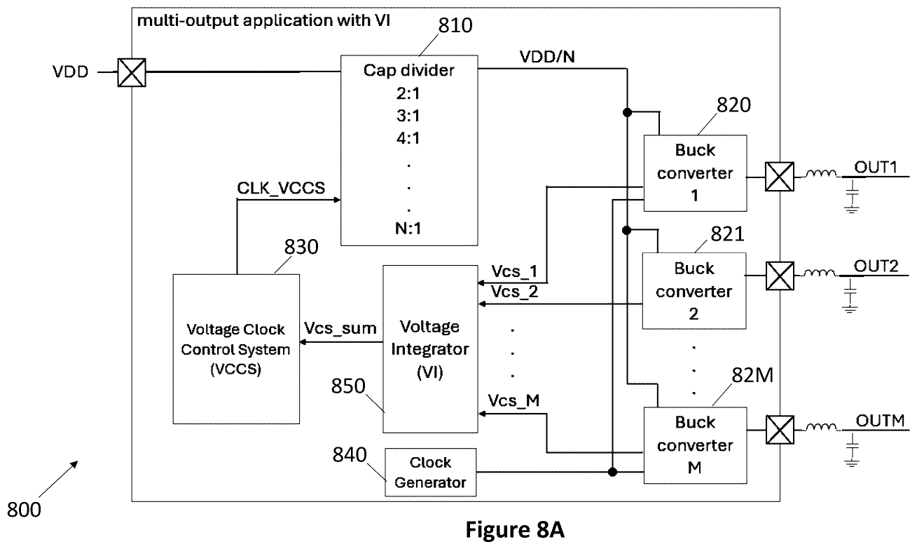

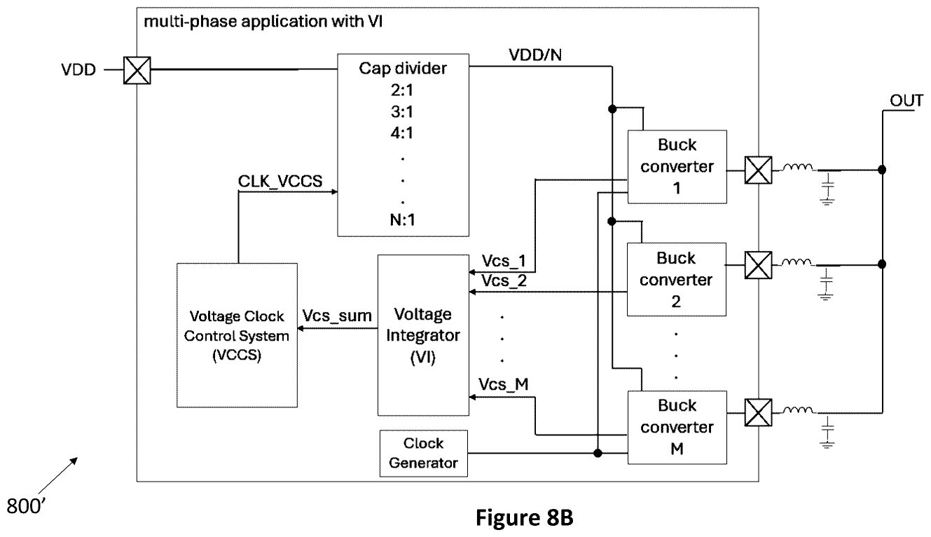

FIG. 8A is a diagram of a multi-output power converter according to the disclosure. The power converter 800 is similar to the power converter 500 of FIG. 5, but in this case the second converter stage includes multiple buck converters coupled to a voltage integrator 850.

The power converter 800 includes a first converter stage 810 that includes a capacitive divider. The second converter stage includes a plurality M of buck converters 820-82M, hence providing multiple outputs: OUT1, OUT2, . . . OUTM. A clock generator 840 is provided to generate the second clock signal to be received by each one of the buck converters 820-82M. The voltage integrator 850 is provided to couple the plurality of buck converters to the voltage clock control system 830.

In operation the voltage integrator 850 receives the current sense voltages Vcs_1 to Vcs_M from the Buck converters 820-82M, and generates a sum voltage Vcs_sum equal to the sum of the voltages Vcs_1 to Vcs_M. The voltage Vcs_sum is used by the VCCS 830 to obtain the total load current iLoad_total for the outputs (OUT1−OUTM). So Vcs_sum corresponds to iLoad_total=IOUT1+IOUT2+ . . . +IOUTM.

The VCCS 830 receives the sum voltage Vcs_sum and generates the first clock signal CLK_VCCS for use by the capacitive divider 810. As explained above the VCCS 830 also adjusts the frequency of the clock signal CLK_VCCS received by the capacitive divider 810. As a result the capacitive divider 810 has good efficiency at light load and good driving capability at heavy load.

FIG. 8B is a diagram of a multi-phase single-output power converter. The power converter 800′ is similar to the power converter 800 of FIG. 8A, but in this case the outputs of each buck converter are combined to provide a single output. In this case Vcs_sum corresponds to iLoad (=IOUT).

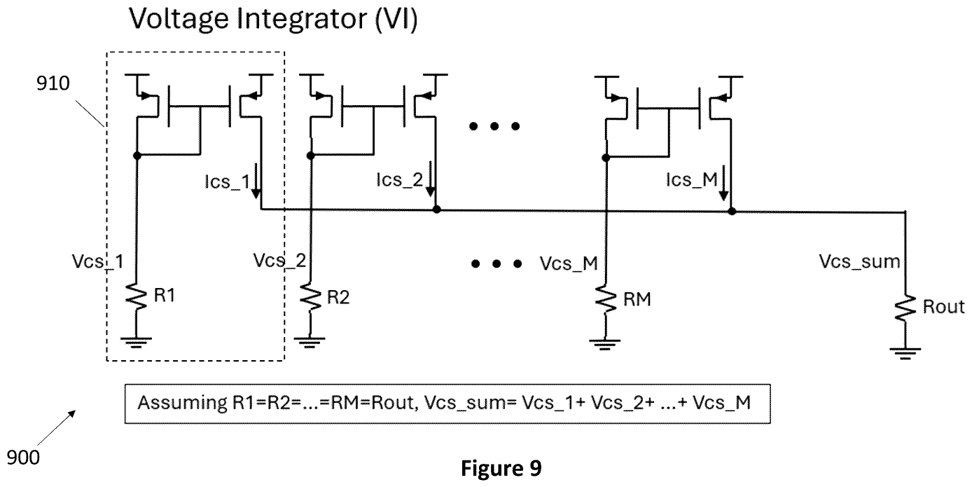

FIG. 9 is an example implementation of a voltage integrator for use in the circuit of FIGS. 8A and 8B. The current integrator 900 includes M cells, in which each cell is formed of a current mirror coupled to a resistance Ri. For instance cell 910 has a current mirror coupled to resistance R1 and outputs the current Ics_1.

The outputs of the first cell is connected to the output of the second cell etc . . . to obtain a total current Itotal equal to the sum of Ics_1 to Ics_M. The total current Itotal is then sent to an output resistance Rout. The resistances Ri are chosen to be equal to each cell and equal to the output resistance Rout so that Vcs_sum=Vcs_1+Vcs_2+ . . . Vcs_M.

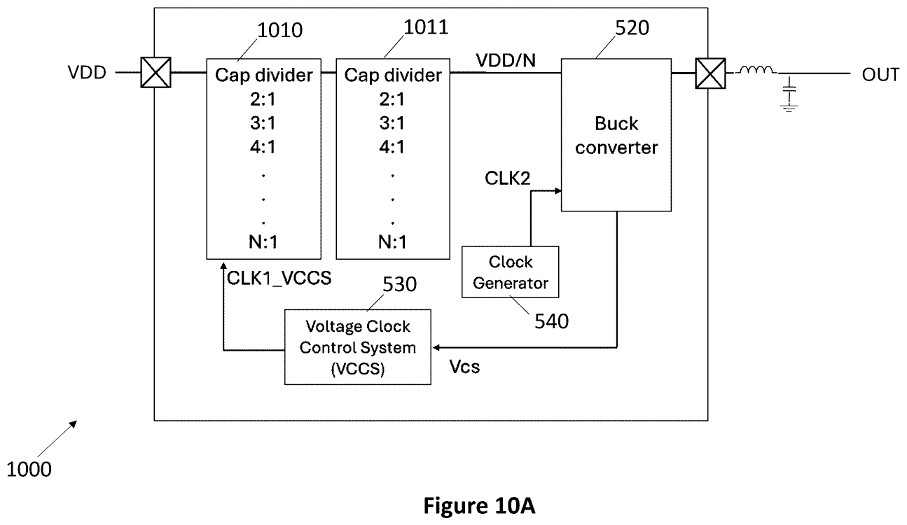

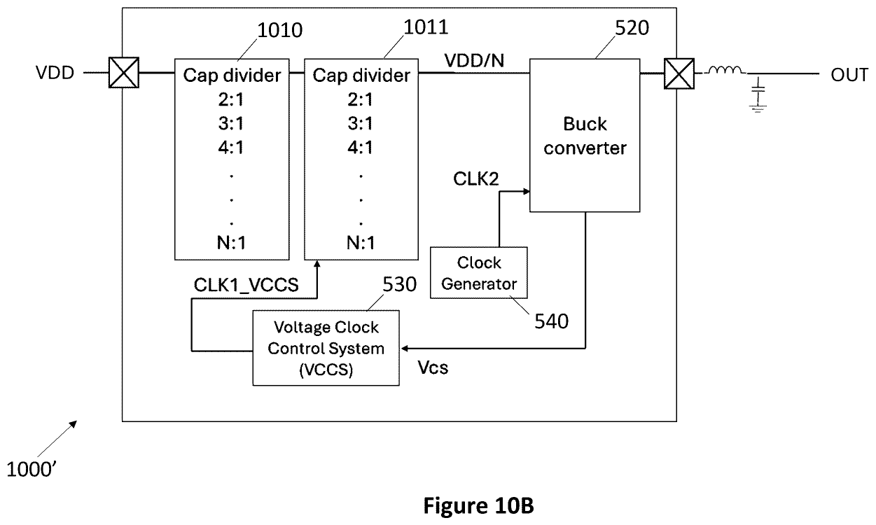

FIG. 10A is a diagram of a power converter with multiple capacitive dividers according to the disclosure. The power converter 1000 is similar to the power converter 500 of FIG. 5, and same reference numerals are used to represent corresponding components, but in this case the first converter stage comprises a plurality of capacitive dividers. In this example two capacitive dividers are provided 1010 and 1011 and the VCCS 530 provides the first clock signal CLK1_VCCS to the first capacitive divider 1010.

FIG. 10B is a modified version of the power converter of FIG. 10A. In this case the VCCS 530 provides the first clock signal CLK1_VCCS to the second capacitive divider 1011. The VCCS 530 adjusts the CLK_VCCS frequency to adjust one of the Cap divider's capabilities to have good efficiency at light load and good driving capability at heavy load.

In an alternative implementation, similar to the design of FIGS. 10A and 10B, the VCCS 530 is configured to send the clock signal to both capacitive dividers 1010 and 1011. Of course it will be appreciated that the number of capacitive dividers may be extended to more than two capacitive dividers, and the VCCS 530 may be implemented to send the clock signal CLK1_VCCS to only one capacitive dividers, or to two capacitive dividers or to more than two capacitive dividers, or to all capacitive dividers present in the circuit.

The power converter of the disclosure can keep a high efficiency at light current load and improve the driving capability at heavy load.

Using the design of FIG. 10A or 10B facilitates the implementation of the capacitive divider circuit. For instance in FIG. 5, the capacitive divider 510 may require a switching circuit coupled to several capacitor, and the switches of the switching circuit are operated (open or closed) to select the desired ratio N:1, for instance 4:1. The switching circuit may require several switches having a significant power rating.

By using multiple capacitive dividers in series it is possible to use simpler designs. For instance a desired ratio of 4:1 may be obtain with a first capacitive divider having a ratio of 2:1 and a second capacitive divider having a ratio of 2:1.

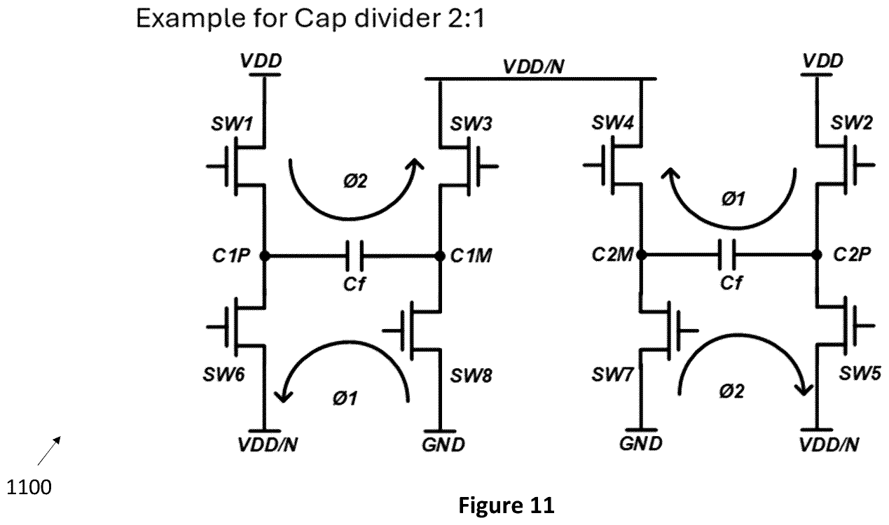

FIG. 11 is a diagram of an exemplary capacitive divider for use in the circuit of FIG. 5 or 8. The capacitive divider 1100 has two capacitors Cf and eight switches SW1-SW8 that may be operated between phase 1 (Φ1) and phase 2 (Φ2) to provide a 2:1 ratio.

As explained above with reference to FIG. 4, when the power converter 400 is implemented as a step up converter, the first converter stage would include one or more charge pump and the second converter stage one or more boost converters.

A skilled person will therefore appreciate that variations of the disclosed arrangements are possible without departing from the disclosure. Accordingly, the above description of the specific embodiments is made by way of example only and not for the purposes of limitation. It will be clear to the skilled person that minor modifications may be made without significant changes to the operation described.

1. A power converter comprising
a first converter stage adapted to receive a first clock signal;
a second converter stage adapted to receive a second clock signal; and
a clock circuit configured to generate the first clock signal and to adjust a frequency of the first clock signal based on a load current.

2. The power converter as claimed in claim 1, wherein the clock circuit is configured to increase the frequency of the first clock signal above a default frequency when the load current increases above a first threshold value and to lower the frequency of the first clock signal below the default frequency when the load current decreases below a second threshold value.

3. The power converter as claimed in claim 1, wherein the clock circuit is configured to estimate the load current based on a sense signal from the second converter stage.

4. The power converter as claimed in claim 3, wherein the sense signal comprises a voltage indicative of an inductor current of the second converter stage.

5. The power converter as claimed in claim 3, wherein the clock circuit comprises an operation frequency control loop coupled to an oscillator, the operation frequency control loop being configured to generate a control signal to adjust the frequency of the first clock signal generated by the oscillator.

6. The power converter as claimed in claim 5, wherein the clock circuit comprises a plurality of comparators, each comparator being configured to compare the sense signal from the second converter stage with a reference value associated with the comparator, and to provide a comparison signal.

7. The power converter as claimed in claim 6, wherein the operation frequency control loop is configured to estimate the load current using a look up table listing a plurality of load current values associated with corresponding sense signal values.

8. The power converter as claimed in claim 1, comprising a clock generator configured to generate the second clock signal.

9. The power converter as claimed in claim 1, wherein the first converter stage comprises one or more capacitive divider; and wherein the second converter stage comprises one or more buck converter.

10. The power converter as claimed in claim 1, wherein the first converter stage comprises a plurality of capacitive dividers coupled in series, and wherein the clock circuit is configured to provide the first clock signal to at least one of the capacitive dividers.

11. The power converter as claimed in claim 1, wherein the first converter stage comprises one or more charge pump; and wherein the second converter stage comprises one or more boost converter.

12. The power converter as claimed in claim 1, wherein the second converter stage comprises a plurality of phases and wherein the power converter further comprises an integrator configured to sum sense signals from each phase.

13. A method of operating a power converter having a first converter stage and a second converter stage, the method comprising
generating a first clock signal for the first converter stage; and
adjusting a frequency of the first clock signal based on a load current.

14. The method as claimed in claim 13, wherein the first clock signal has a default frequency, the method further comprising
estimating the load current;
increasing the frequency of the first clock signal above the default frequency when the load current increases above a first threshold value; and
lowering the frequency of the first clock signal below the default frequency when the load current decreases below a second threshold value.

15. The method as claimed 14, comprising maintaining the first clock signal with the default frequency when the load current is between the first threshold value and the second threshold value.
